(19) United States
(12) Patent Application Publication
(10) Pub. No.: US 2006/0039162 A1
(43) Pub. Date: Feb. 23, 2006

(54) LIGHT GUIDE PLATE AND MANUFACTURING METHOD THEREOF

(76) Inventors: HAN-JUNG CHEN, Hsinchu (TW); CHIEN-HUNG HSU, Hsinchu (TW); RUEI-JEN WANG, Hsinchu (TW)

Correspondence Address: NORTH AMERICA INTELLECTUAL PROPERTY CORPORATION, P.O. BOX 506, MERRIFIELD, VA, 22116, US

(21) Appl. No.: 10/711,999

(22) Filed: Oct. 19, 2004

(30) Foreign Application Priority Data
Aug. 17, 2004 (TW) 093124732

(51) Int. Cl. F21V 7/04

(52) U.S. Cl. 362/600

(57) ABSTRACT

A method for patterning a light guide plate (LGP) is disclosed. The method includes a step of using laser beams to form a roughened surface on a mold, and a step of manufacturing the light guide plate with the mold so that a roughened surface containing micro-mirror structures is formed on the surface of the light guide plate.

### BACKGROUND OF INVENTION

1. Field of the Invention

The present invention relates to a method for manufacturing a light guide plate, and more particularly, to a method for manufacturing a light guide using a mold having a roughened surface formed by laser beams so that a roughened surface having of micro-mirror structures is formed on the surface of the light guide plate.

2. Description of the Prior Art

Backlight units are known in the art. The backlight unit, which is a key element in the fabrication of liquid crystal displays (LCDs), is widely used in monitors, notebooks, digital cameras, projectors and so on. Backlight units are typically divided into two major categories: edge-type and direct-type, wherein a light source of the edge-type backlight unit is positioned on the lateral side of the display panel so as to reduce the size and cost of the liquid crystal display.

Please refer to FIG. 1. FIG. 1 is a diagram of a conventional edge-type backlight module 10 in the prior art. The edge-type backlight module 10 includes a light guide plate 14 installed below a display panel 12, a plurality of lamps 16 installed on a lateral side of the light guide plate 14, which can be cold cathode fluorescent lamps (CCFL), a lamp cover 18 installed outside the lamps 16, a reflecting sheet 20 installed below the light guide plate 14 for reflecting light emitted through the light guide plate 14 downward back to the light guide plate 14, an optical material layer 22 installed between the light guide plate 14 and the display panel 12, and two lamp fixtures 24 installed on both sides of the lamps 16 for fixing the lamps 16. The lamps 16 can emit light to the display panel 12, and the lamp cover 18 and the reflecting sheet 20 can reflect the light emitted from the lamps 16 to the light guide plate 14 so as to increase a light utility rate. Micro-scattering points positioned on the bottom of the light guide plate 14 can interfere with the total reflection of light inside the light guide plate 14 so that the light can be refracted outside the light guide plate 14 and into the optical material layer 22. The optical material layer 22 can mist and focus the light refracted from the light guide plate 14 for providing light to the display panel 12.

As described above, the light guide plate 14 is one of the important parts of the edge-type backlight module 10. A pattern in formed on the bottom of the light guide plate 14 that guides the light uniformly in order to increase the luminance of the display panel 12 and to ensure the uniformity of brightness in the display panel 12. Conventional methods for patterning the light guide plate can be divided into two types according to the manufacturing process.

The first one is screen printing which utilizes materials with a high reflection ratio and non-absorbance characteristics on an acrylic plate to form circular or rectangular patterns on the light guide plate 14. The second one is to form a patterned light guide plate 14 directly by injection molding as shown in FIG. 2. FIG. 2 shows a conventional injection molding of the light guide plate 14. First, a patterned metal film 26 is attached to a female mold (or mirror mold) 28. A male mold 30 and the female mold 28 are then assembled together. A material to form the light guide plate 14 (typically propylene, also known as acrylic) is then injected along the direction shown by the arrow from an injection spout of the male mold 30 into a mold cavity 32. The pattern is transcripted onto the acrylic plate by an injector or a hot press. The pattern of the light guide plate 14 can be formed on the patterned metal film 26 by a sand-blasting method or an etching method.

The pattern with a mist or drop surface of the light guide plate 14 is formed on the patterned metal film by a sand blasting method or an etching method in the prior art. However, the sand blasting method and the etching method are difficult to reproduce, causing distortion of the pattern and causing the distortion bias of the light distribution to occur. In addition, the prior art method is not very precise at controlling the density of the patterns on the light guide plate by adjusting the roughness distribution of the sand-blasting surface. Hence the prior art cannot reliably fabricate the sand-blasting mist surface with the same roughness. This creates a problem in adjusting the light uniformly of the backlight module.

### SUMMARY OF INVENTION

It is therefore a primary objective of the claimed invention to provide a light guide plate and a method for manufacturing a light guide plate for solving the above-mentioned problem.

It is another primary objective of the claimed invention to provide a light guide plate structure for increasing the brightness within the viewing angle.

According to the claimed invention, a method for patterning a light guide plate includes using laser beams to form a roughened surface on a mold and manufacturing the light guide plate with the mold.

According to the claimed invention, an edge-light backlight module includes a light source, and a light guide plate installed on a lateral side of the light source. The light guide plate includes a light-guiding surface and a bottom surface positioned below the light-guiding surface, the bottom surface being a roughened surface formed of micro-mirror structures.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a diagram of a conventional edge-type backlight module in the prior art.

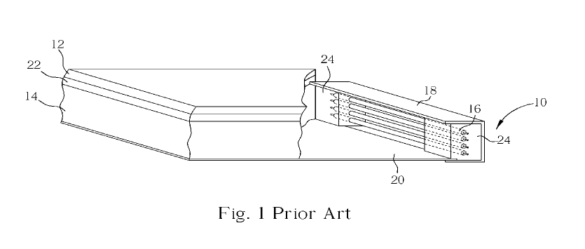

FIG. 2 shows a conventional injection molding of a light guide plate.

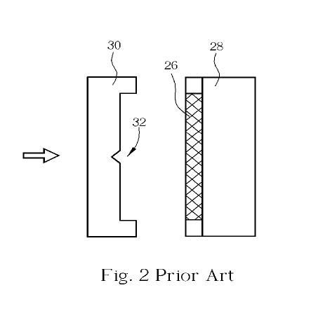

FIG. 3 is a diagram of an edge-type backlight module according to the present invention.

FIG. 4 is a perspective view of a light guide plate.

FIG. 5 is a flowchart of the fabrication of the light guide plate according to the present invention.

FIG. 6 is a perspective view of the light guide plate of another embodiment.

### DETAILED DESCRIPTION

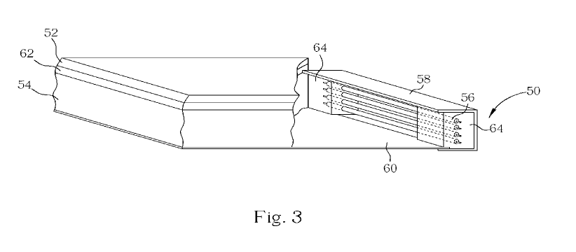

Please refer to FIG. 3. FIG. 3 is a diagram of an edge-type backlight module 50 according to the present invention. The edge-type backlight module 50 includes a light guide plate 54 installed below the display panel 52, a light source 56 installed on a lateral side of the light guide plate 54, which can be a plurality of cold cathode fluorescent lamps (CCFL), a lamp cover 68 installed outside the light source 56, a reflecting sheet 60 installed below the light guide plate 54, an optical material layer 62 installed between the light guide plate 54 and the display panel 52, and two lamp fixtures installed on the both sides of the light source 56 for fixing the light source 56. The lamp cover 68 and the reflecting sheet 60 can reflect the light emitted from the light source 56 to the light guide plate 54, and the light guide plate 54 can scatter the light emitted from the light source 56 to the optical material layer 62 so as to provide the display panel 52 with the light in uniformity and larger angle of vision.

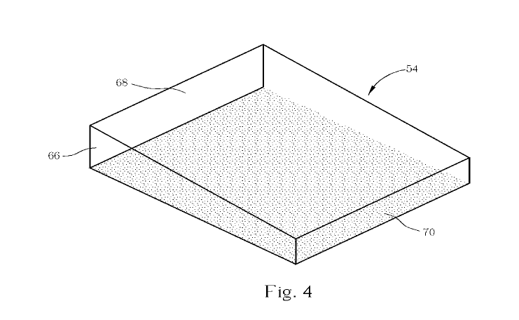

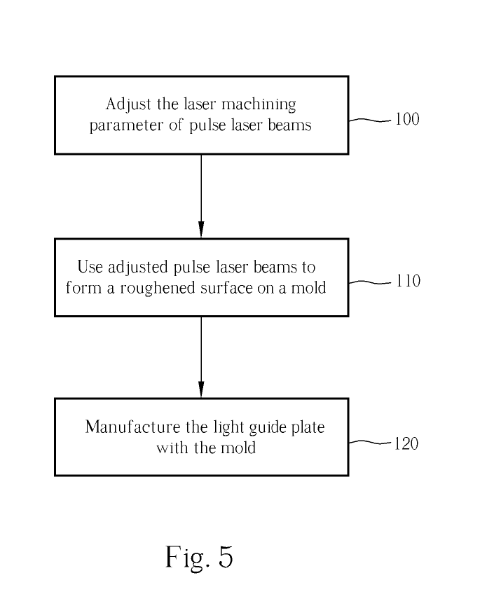

Please refer to FIG. 4. FIG. 4 is a perspective view of the light guide plate 54. The light guide plate 54 includes a transparent body 66, which can be made of acrylic material. The transparent body 66 includes a bottom surface 70 and a light-guiding surface 68. The bottom surface 70 is positioned below the light-guiding surface 68, and the bottom surface 70 is a roughened surface. Please refer to FIG. 5. FIG. 5 is a flowchart of the fabrication of the light guide plate 54 according to the present invention. The method includes the following steps:

Step 100: Adjust the laser machining parameter of pulse laser beams.

Step 110: Use adjusted pulse laser beams to form a roughened surface on a mold.

Step 120: Manufacture the light guide plate 54 with the mold.

First the laser machining parameter of pulse laser beams can be adjusted, such as the intensity, frequency, or shoot number of the pulse laser beams, for controlling the sunken level and the density of the cavities on the surface of the mold formed by the pulse laser beams. The pulse laser beams can be Nd-YAG laser beams used for hitting the surface of the mold so as to form a roughened surface. The mold can be made of steel or acrylic material, and so on. The energy of the pulse laser beams can fuse the surface of the mold so as to form micro-mirror structures in the positions where the laser beams hit due to the cohesion and the surface tension of the material of the mold. Next the light guide plate 54 can be manufactured with the mold as a female mold by injection molding or a thermoforming method, and the bottom surface 70 of the light guide plate 54 is relative to the roughened surface of the mold hit by laser beams. Furthermore, a rollover mold can be formed by rolling over the mold in an electroforming method as a female mold so as to manufacture the light guide plate 54 with the rollover mold by injection molding or a thermoforming method, and the surface structure of the light guide plate 54 is the same as the surface structure of the mold hit by laser beams.

The bottom surface 70 of the light guide plate 54 is a roughened surface having micro-mirror structures so that the light-reflecting efficiency can be increased via the micro-mirror structure and the total light-emitting efficiency can also be increased. In addition, the roughened surface formed by the laser beams can be fabricated not only on the bottom surface of the light guide plate but also on the light-guiding surface of the light guide plate.

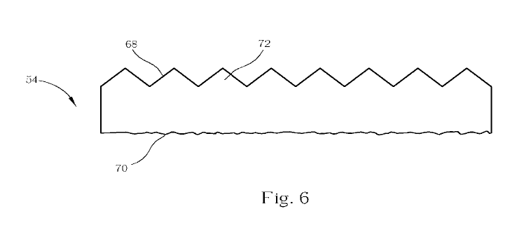

Please refer to FIG. 6. FIG. 6 is a perspective view of the light guide plate 54 of another embodiment. The light-guiding surface 68 is formed of linear prism structures 72 created side by side. When light emits into the light guide plate 54, the light can be scattered via the roughened surface of the bottom surface 70 and then be refracted or reflected via the linear prism structures 72 so as to focus the light within a range of viewing angles for increasing the brightness.

In contrast to the prior art, the method for forming the bottom surface structure of the light guide plate according to the present invention involves utilizing pulse laser beams to fabricate the mold for the light guide plate so as to form a roughened surface in micro-mirror structures on the bottom of the light guide plate for increasing the light-emitting efficiency. In addition, because the laser machining for the mold is precise, the pattern distribution of the light guide plate can be controlled by adjusting laser machining parameters so as to control the uniformity of brightness in the backlight module, and the reproducibility of the mold can also be improved. In conclusion, the method according to the present invention raises the light-emitting efficiency and quality of the light guide plate and lowers the cost so that competitiveness is increased.

Those skilled in the art will readily observe that numerous modifications and alterations of the method and the device may be made while retaining the teachings of the invention. Accordingly, the above disclosure should be construed as limited only by the metes and bounds of the appended claims.

What is claimed is:

1. A method for patterning a light guide plate comprising:
(a) using laser beams to form a roughened surface on a mold; and
(b) manufacturing the light guide plate with the mold.

2. The method of claim 1 wherein step (a) further comprises using Nd-YAG laser beams to form the roughened surface on the mold.

3. The method of claim 1 wherein step (a) further comprises using pulse laser beams to form the roughened surface on the mold.

4. The method of claim 1 further comprises adjusting a laser machining parameter for controlling roughness of the roughened surface on the mold.

5. The method of claim 1 wherein the roughened surface comprises micro-mirror structures.

6. The method of claim 1 wherein step (b) further comprises manufacturing the light guide plate with the mold by injection molding.

7. The method of claim 1 wherein step (b) further comprises manufacturing the light guide plate with the mold in a thermoforming method.

8. The method of claim 1 wherein step (b) further comprises forming a rollover mold by rolling over the mold in an electroforming method and manufacturing the light guide plate with the rollover mold.

9. An edge-light backlight module comprising:
a light source; and
a light guide plate installed on a lateral side of the light source, the light guide plate comprising:
a light-guiding surface; and
a bottom surface positioned below the light-guiding surface, the bottom surface being a roughened surface formed of micro-mirror structures.

10. The edge-light backlight module of claim 9 wherein the light-guiding surface is formed of linear prism structures.

11. An edge-light backlight module comprising:
a light source; and
a light guide plate installed on a lateral side of the light source, the light guide plate comprising:
a light-guiding surface being a roughened surface formed of micro-mirror structures; and
a bottom surface positioned below the light-guiding surface.
